(19) United States
(12) Patent Application Publication
(10) Pub. No.: US 2026/0136435 A1
(43) Pub. Date: May 14, 2026

(54) STRIP HEATING APPARATUS

(71) Applicants: Robert W. Ashcraft, El Dorado, CA (US); Neil Lykken, El Dorado, CA (US)

(72) Inventors: Robert W. Ashcraft, El Dorado, CA (US); Neil Lykken, El Dorado, CA (US)

(21) Appl. No.: 18/945,121

(22) Filed: Nov. 12, 2024

(51) Int. Cl. H05B 3/06

(52) U.S. Cl. CPC H05B 3/06; H05B 2203/017

(57) ABSTRACT

A strip heating apparatus and a method of producing the strip heating apparatus are described. The strip heating apparatus comprises a housing unit with openings, a plurality of support bulkhead structures with protrusions positioned within the housing unit, the support bulkhead structures being secured to the housing unit by the protrusions of the support bulkhead structures in the openings of the housing unit, a heating element positioned on the support bulkhead structures within the housing unit, and a linear bar positioned near the heating element and secured in the housing unit so that at least a portion of the linear bar is exposed through the housing unit to interface with a target object.

### BACKGROUND OF THE INVENTION

Strip heaters are commonly used to heat plastic-containing objects, such as polyvinyl chloride (PVC) objects, so that the plastic-containing objects can be bent as needed. As their name implies, strip heaters can heat target objects using heating elements along linear strips so that the target objects can be bent at the heated linear strips. Commonly used heating elements include linear heating wires and linear tubular heating elements (e.g., a type of heating elements commonly found in electric ovens).

Strip heaters may be used to bend plastic-containing building materials, such as flooring and wall cladding materials made of stone plastic composite (SPC) and wood plastic composite (WPC). Thus, strip heaters can be used at construction or remodeling sites to customize the building materials to meet specific needs at the sites. As an example, wall cladding sheets may be bent to accommodate corners to provide a clean crisp factory look.

One of the disadvantages of conventional strip heaters is that the design of the strip heaters does not effectively manage expansion of various components of the strip heaters due to the extreme heat generated by the heating elements. Thus, various components of the strip heaters may expand and place significant amount of structural stress on the strip heaters, which may cause the strip heaters to perform poorly, malfunction or even fail.

### SUMMARY OF THE INVENTION

A strip heating apparatus and a method of producing the strip heating apparatus are described. The strip heating apparatus in accordance with an embodiment of the invention comprises a housing unit with openings, a plurality of support bulkhead structures with protrusions positioned within the housing unit, the support bulkhead structures being secured to the housing unit by the protrusions of the support bulkhead structures in the openings of the housing unit, a heating element positioned on the support bulkhead structures within the housing unit, and a linear bar positioned near the heating element and secured in the housing unit so that at least a portion of the linear bar is exposed through the housing unit to interface with a target object.

The method of producing a strip heating apparatus in accordance with an embodiment of the invention comprises providing a housing unit with openings of the strip heating apparatus, positioning a plurality of support bulkhead structures with protrusions within the housing, wherein the support bulkhead structures are secured to the housing unit by snapping the protrusions of the support bulkhead structures into the openings of the housing unit, positioning a heating element on the support bulkhead structures within the housing unit, and positioning a linear bar near the heating element in the housing unit so that at least a portion of the linear bar is exposed through the housing unit to interface with a target object.

A strip heating apparatus in accordance with another embodiment comprises a housing unit with openings, a plurality of support bulkhead structures with tabs positioned within the housing unit, the support bulkhead structures being secured to the housing unit by the tabs of the support bulkhead structures in the openings of the housing unit, a linear heating element positioned on the support bulkhead structures within the housing unit, and a linear T bar positioned near the linear heating element in the housing unit so that at least a portion of a stem of the linear T bar is exposed through the housing unit to interface with a target object.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 shows a strip heating apparatus in accordance with an embodiment of the invention.

FIG. 2 is a perspective view of an outer housing of the strip heating apparatus with other components of the strip heating apparatus in accordance with an embodiment of the invention.

FIG. 3 shows a representative support bulkhead with tabs of the strip heating apparatus that can be used in the strip heating apparatus in accordance with an embodiment of the invention.

FIG. 4 shows the support bulkhead of FIG. 3 positioned with other components of the strip heating apparatus in accordance with an embodiment of the invention.

FIG. 5 shows the support bulkhead of FIG. 3 positioned within the outer housing with the other components of the strip heating apparatus in accordance with an embodiment of the invention.

FIG. 6 is a perspective view of the support bulkhead of FIG. 3 positioned within the outer housing with a channel structure in accordance with an embodiment of the invention.

FIG. 7 is another perspective view of the support bulkhead of FIG. 3 positioned within the outer housing with the channel structure in accordance with an embodiment of the invention.

FIG. 8 is a detailed view of a T bar support structure of the strip heating apparatus in accordance with an embodiment of the invention.

FIG. 9 shows a representative end bulkhead of the strip heating apparatus in accordance with an embodiment of the invention.

FIG. 10 shows a representative heating element bulkhead of the strip heating apparatus in accordance with an embodiment of the invention.

FIG. 11 is a perspective view of one of the end bulkheads and one of the heating element bulkheads positioned within the outer housing in accordance with an embodiment of the invention.

FIGS. 12A and 12B illustrates a process of using the strip heating apparatus in accordance with an embodiment of the invention.

FIG. 13 is a flow diagram of a method of producing a strip heating apparatus in accordance with an embodiment of the invention.

### DETAILED DESCRIPTION

The components of the embodiments as generally described in this document and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

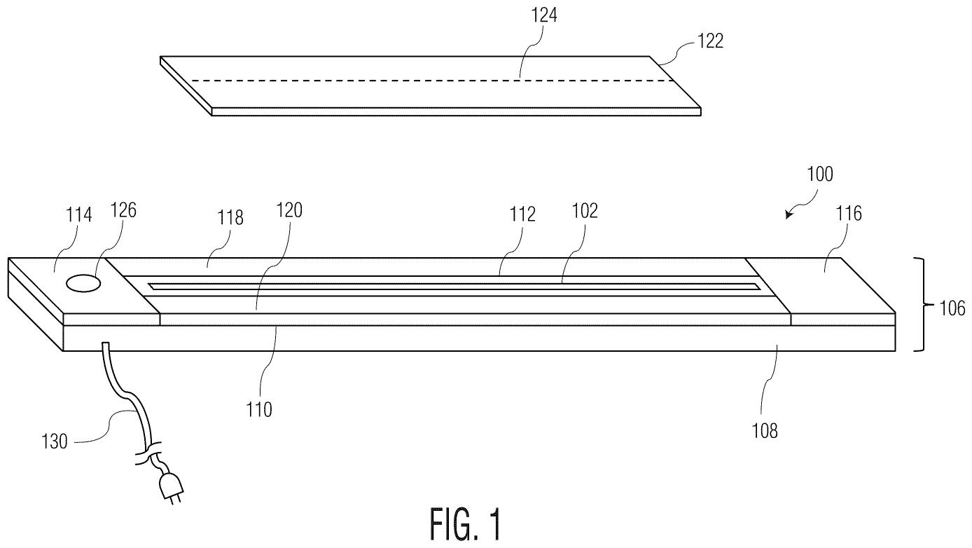

Turning now to FIG. 1, a strip heating apparatus 100 for bending target objects in accordance with an embodiment of the invention is shown. The target objects can be any object that is malleable by the application of heat. As an example, the target object may be objects made of plastic-containing material, including plastic-containing building materials, such as polyvinyl chloride (PVC), stone plastic composite (SPC) and wood plastic composite (WPC) materials. Thus, the strip heating apparatus 100 can be used to create stair treads, caps and corner (inside and outside) flooring and wall pieces. Although the strip heating apparatus 100 is described with respect to plastic-containing objects, the strip heating apparatus 100 may be used on other heat-malleable objects so that the objects can be bent as desired. Unlike conventional strip heaters, the strip heating apparatus 100 is designed to effectively manage expansions of various components of the strip heating apparatus due to high operating temperatures, as described in detail below. Thus, the strip heating apparatus 100 is able to significantly reduce or remove structural stresses caused by heat expansion of the components of the strip heating apparatus.

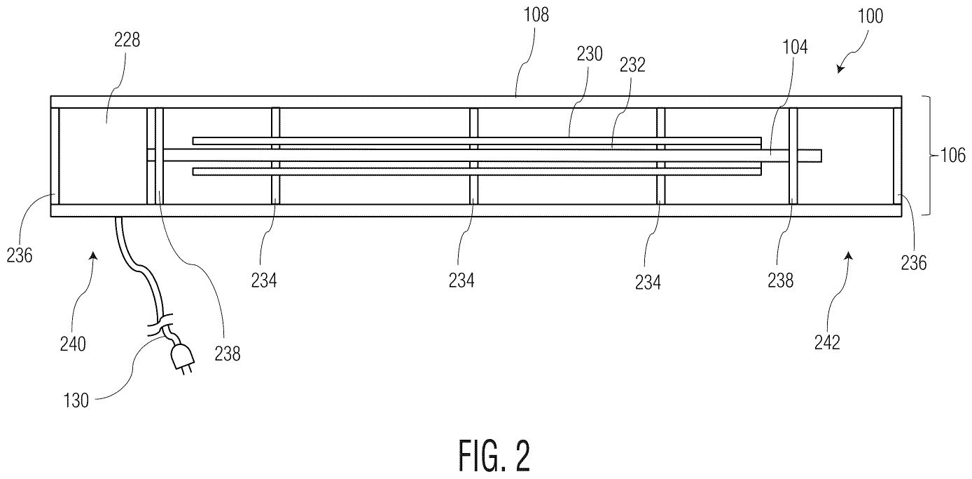

As shown in FIG. 1, the strip heating apparatus 100 includes a linear T bar 102, which gets heated by a heating element 104 (not visible in FIG. 1, but shown in FIG. 2), that is partially situated in a housing unit 106 of the strip heating apparatus. The housing unit 106 comprises an outer housing 108 and a cover structure 110, which covers the outer housing. The cover structure 110 includes a linear opening 112 that is designed to accommodate the linear T bar 102. The cover structure 110 includes end covers 114 and 116, and linear covers 118 and 120, which are separated to create the linear opening 112. In FIG. 1, only the bottom portion or stem of the linear T bar 102 is shown, which protrudes out of the linear opening 112 of the cover structure 110 of the housing unit 106 to interface or engage a target plastic-containing object 122. Thus, the linear T bar 102 is used to heat a linear strip 124 of the target plastic-containing object 122 in order to bend the target plastic-containing object at the heated linear strip as needed. The linear T bar 102 and other components of the strip heating apparatus 100 within the outer housing of the housing unit will be described in detail below.

Also shown in FIG. 1, is a control knob 126 of the strip heating apparatus 100 to change the setting of the strip heating apparatus to heat the target plastic-containing object 122. The control knob 126 is connected to a controller 228 (not visible in FIG. 1, but shown in FIG. 2), which provides power to the linear heating element 104 (also not visible in FIG. 1, but shown in FIG. 2) so that heat is generated by the linear heating element, which heats up the linear T bar 102. In an embodiment, the control knob 126 includes a preheating setting as well as numbered settings to control the temperature of the strip heating apparatus 100 when in operation. In a typical operation, the strip heating apparatus 100 is first preheated for ten (10) to fifteen (15) minutes by turning the control knob 126 to the preheating setting. Then, the control knob 126 is turned to a desired setting (i.e., one of the numerical settings) to heat the target plastic-containing object 122 in order to bend the target plastic-containing object along the linear strip 124.

The strip heating apparatus 100 further includes a power cord 130 that can be plugged into an electrical outlet. Depending on its size, the strip heating apparatus 100 may only draw few amps using 120 volts. As an example, if the size of the strip heating apparatus 100 is six (6) feet long with a heated width of ⅛ inch (i.e., the width of the exposed portion of the linear T bar 102), then the strip heating apparatus may require 120 volts/350 watts, and may only draw just 3.0 amps. As another example, if the size of the strip heating apparatus 100 is ten (10) feet long with a heated width of ⅛ inch, then the strip heating apparatus may require 120 volts/580 watts, and may only draw just 4.8 amps. Thus, the strip heating apparatus 100 can be plugged in almost anywhere.

Turning now to FIG. 2, the structural components of the strip heating apparatus 100 within the outer housing 108 of the housing unit 106 in accordance with an embodiment of the invention are shown. As shown in FIG. 2, the strip heating apparatus 100 includes a channel structure 230 with a rectangular channel 232 in which the linear heating element 104 is positioned. The linear heating element 104 can be any type of an electric heating element, which generates heat using electric current. As an example, the linear heating element 104 may be a linear heating wire or a linear tubular heating element (e.g., a type of heating elements commonly found in electric ovens).

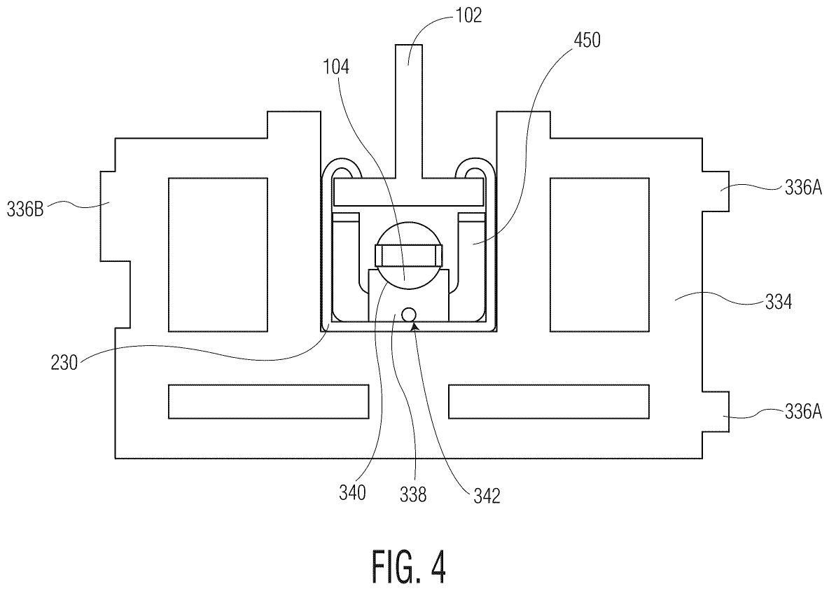

The linear T bar 102 is positioned over the linear heating element 104 within the channel structure using a number of T bar support elements (not shown in FIG. 2, but shown in FIG. 4). The linear T bar 102 is orientated so that the bottom portion or stem of the linear T bar points away from the linear heating element 104, i.e., the top portion or bar of the linear T bar faces the linear heating element. As illustrated in FIG. 1, the linear T bar 102 is positioned so that a portion of the stem of the linear T bar protrudes out of the linear opening 112 of the cover structure 110 when the cover structure is placed on the outer housing 108 of the housing unit 106. The exposed portion of the linear T bar 102 is used to engage or interface with a target plastic-containing object, e.g., the target plastic-containing object 122 shown in FIG. 1, during a heating operation, which may involve physically contacting the target plastic-containing object with the exposed portion of the linear T bar or positioning the exposed portion of the linear T bar close to the target plastic-containing object without actually touching the target plastic-containing object.

The channel structure 230 is supported within the outer housing 108 of the housing unit 106 using a number of support bulkhead structures 234 (referred to herein as “support bulkheads”). These support bulkheads 234 are positioned in place in the outer housing 108 using a non-adhesive methodology. That is, the support bulkheads 234 are not glued, welded, screwed, riveted or otherwise physically joined to the outer housing. Rather, the support bulkheads 234 are snapped in place at particular locations in the outer housing 108. In other words, the support bulkheads 234 are held in place without being adhesively attached to the outer housing 108 so that the support bulkheads are not immovable with respect to the outer housing, i.e., the support bulkheads can move slightly or wiggle from the outer housing, which allows the support bulkheads to expand when exposed to heat without significantly experiencing or significantly causing structural stress from being adhesively attached to the outer housing of the housing unit. In addition, as described further below, the manner in which the support bulkheads 234 are positioned in place in the outer housing 108 minimizes or significantly reduces the amount of heat that is transferred from the support bulkheads to the support housing.

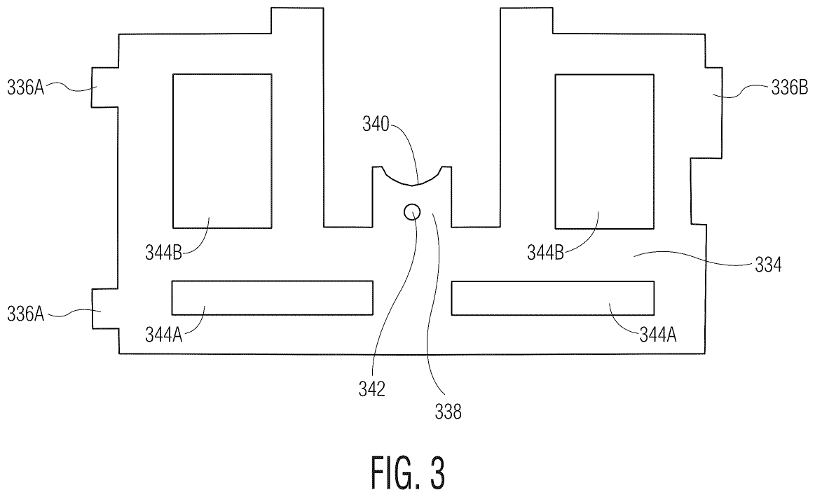

In an embodiment, the support bulkheads 234 are held in place in the outer housing 108 using protrusions in the form of tabs, which are inserted, placed or snapped into openings in the outer housing. A representative support bulkhead 334 with tabs in accordance with an embodiment of the invention is illustrated in FIG. 3. The support bulkhead 334 may be made of any metal, such as aluminum. The support bulkhead 334 includes two (2) tabs 336A on one side and a single tab 336B on the other opposite side. These tabs 336A and 336B are used to secure the support bulkhead 334 in place when placed in corresponding openings in the outer housing 108. Although the support bulkhead 334 includes three (3) tabs on the opposite sides in the illustrated embodiment, the support bulkhead may have different number of tabs in other embodiments, which may be located on any of the four sides of the support bulkhead. It is noted here that the support bulkheads may not be rectangular in shape in other embodiments. The shape of the support bulkheads may vary depending on the overall design of the strip heating apparatus.

As shown in FIG. 3, the support bulkhead 334 also includes a support portion 338 with a concaved edge 340, which is located near the center of the support bulkhead. The concaved edge 340 of the support portion 338 is used to support the linear heating element 104. That is, the linear heating element 104 can be placed on the concaved edge 340 of the support portion 338 of the support bulkhead 334. Thus, the linear heating element 104 can be supported within the outer housing 108 using the concaved edges of multiple support bulkheads that are same or similar to the support bulkhead 334. The support portion 338 of the support bulkhead 334 includes a hitch pin hole 342, which is used to secure the channel structure to the support bulkhead, as described below.

The support bulkhead 334 further includes voids or spaces. In the illustrated embodiment, the support bulkhead 334 includes two (2) small rectangular spaces 344A and two (2) larger rectangular spaces 344B. However, in other embodiments, the support bulkhead 334 may include any number of spaces, which may be rectangular in shape or any other shape. The spaces in the support bulkhead 334 allow heat from the linear heating element 104 to dissipate as quickly as possible and allow less heat to be transferred from the linear heating element to the outer housing 108 and other components of the strip heating apparatus through the support bulkhead.

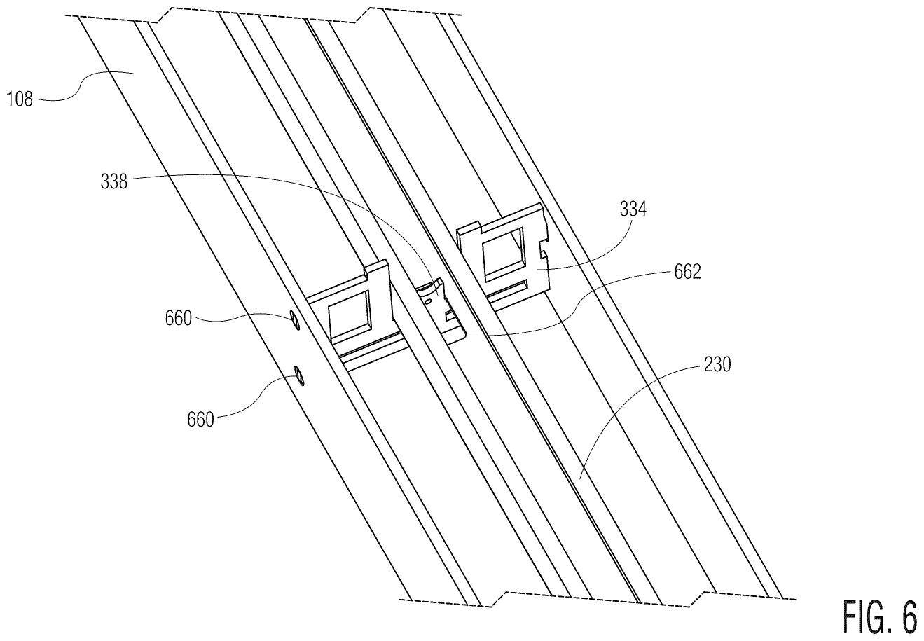

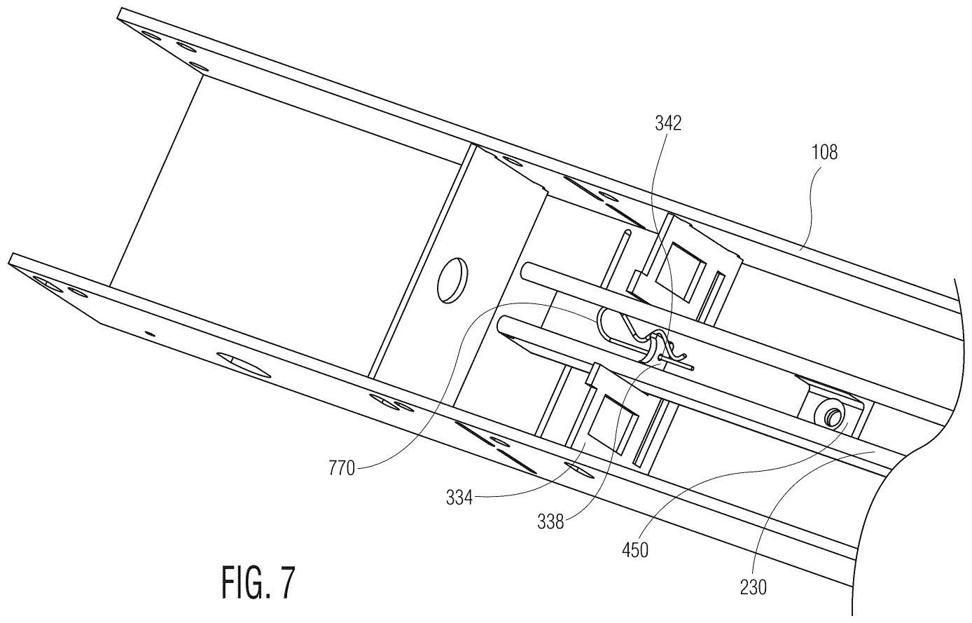

Turning now to FIG. 4, the support bulkhead 334 is shown to be positioned with other components of the strip heating apparatus 100 in accordance with an embodiment of the invention. As illustrated in FIG. 4, the linear T bar 102 is held in place in the channel structure 230 with a T bar support structure 450, which sits within the channel structure to support the linear T bar 102. In an embodiment, the T bar support structure 450 may be screwed on to the channel structure 230 or otherwise fastened to the channel structure. The strip heating apparatus 100 may include a number of these T bar support structures along the channel structure 230, depending on the size of the strip heating apparatus. The linear heating element 104 rides or sits on the concaved edge 340 of the support portion 338 of the support bulkhead 334 without being physically attached to the support bulkhead, which allows the linear heating element to expand when heated. The channel structure 230 fits over the support bulkhead 334. In particular, the support portion 338 of the support bulkhead 334 is positioned in an expansion groove opening 662 (not visible in FIG. 4, but shown in FIG. 6) of the channel structure 230, and the channel structure is held in place with a hitch pin (not shown in FIG. 4, but shown in FIG. 7), which is inserted in the hitch pin hole 342 in the support bulkhead 334.

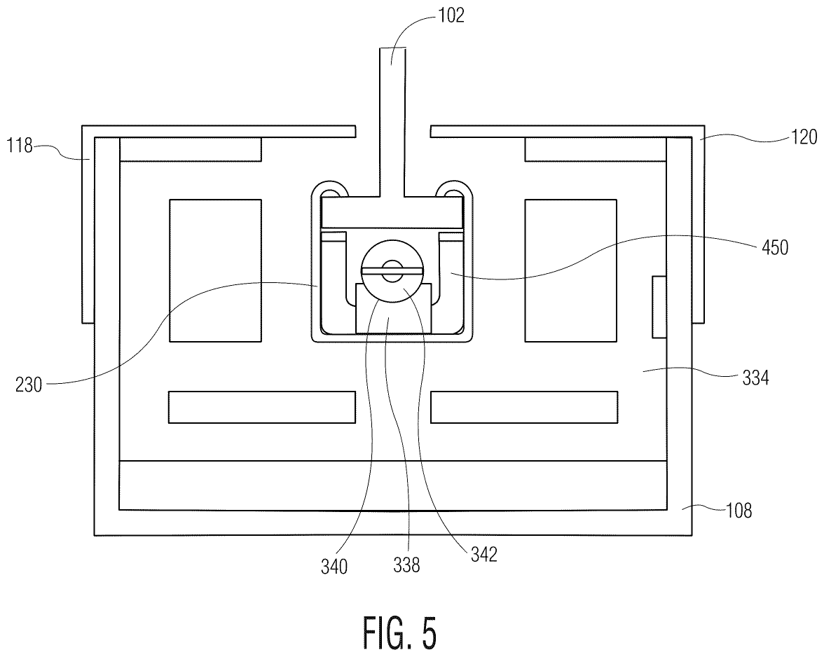

Turning now to FIG. 5, the support bulkhead 334 is shown positioned within the outer housing 108 with the other components of the strip heating apparatus 100 in accordance with an embodiment of the invention. As illustrated in FIG. 5, the tabs 336A and 336B (not visible in FIG. 5, but shown in FIG. 4) of the support bulkhead 334 are used to secure the support bulkhead to the outer housing 108. Thus, the support bulkhead 334 is fixed at a particular location on the outer housing 108 without being physically attached or adhered to the outer housing. Also shown in FIG. 5 are the linear covers 118 and 120 of the cover structure 110, which enclose the linear heating element 104 and other internal components of the strip heating apparatus 100. However, the stem of the linear T bar 102 protrudes from the linear opening 112 of the cover structure 110, which is created by the linear covers 118 and 120.

FIG. 6 is a perspective view of the support bulkhead 334 positioned within the outer housing 108 with the channel structure 230 in accordance with an embodiment of the invention. As shown in FIG. 6, the tabs 336A and 336B (not visible in FIG. 5, but shown in FIG. 4) of the support bulkhead 334 are inserted into openings 660 in the outer housing 108, which secures the support bulkhead to the outer housing. In the illustrated embodiment, the openings 660 in the outer housing 108 are circular in shape. However, in other embodiments, the openings 660 in the outer housing 108 may be rectangular or another appropriate shape to secure the tabs of the support bulkhead. In addition, the support portion 338 of the support bulkhead 334 is inserted to an expansion groove opening 662 in the channel structure 230, which allows the support bulkhead to expand when exposed to the heat from the linear heating element 104 during operation.

FIG. 7 is another perspective view of the support bulkhead 334 positioned within the outer housing 108 with the channel structure 230 in accordance with an embodiment of the invention. As shown in FIG. 7, the channel structure 230 is placed on the support bulkhead 334 so that the support portion 338 of the support bulkhead is inserted through the channel structure, which exposes the hitch pin hole 342 in the support portion of the support bulkhead. The channel structure 230 is secured to the support bulkhead 334 by a hitch pin 770 through the hitch pin hole 342 in the support portion 338 of the support bulkhead 334.

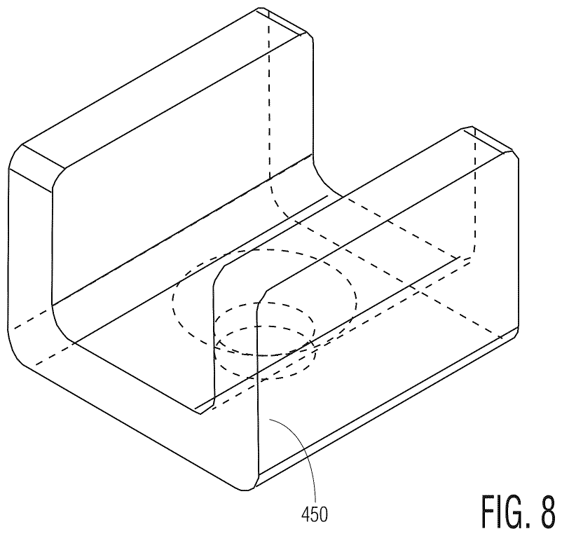

As shown in FIG. 7, the T bar support structure 450 is positioned in the channel structure 230. A more detailed view of the T bar support structure in accordance with an embodiment of the invention is shown in FIG. 8. Also shown in FIG. 7 is one of two (2) heating element bulkhead structures 238 (referred to herein as “heating element bulkheads”) of the strip heating apparatus. The heating element bulkheads 238 are described below.

Turning back to FIG. 2, in addition to the support bulkheads 234, the strip heating apparatus includes two (2) end bulkhead structures 236 (referred to herein as the “end bulkheads”) and the two (2) heating element bulkheads 238. The end bulkheads 236 are positioned at the opposite ends of the outer housing 108 of the strip heating apparatus 100. Each of the heating element bulkheads 238 is positioned between one of the end bulkheads 236 and the support bulkhead 234 closest to that end bulkhead. The end and heating element bulkheads 236 and 238 are described in more detail below.

The placement of the heating element bulkheads 238 adjacent to the end bulkheads 236 creates two (2) spaces 240 and 242 in the outer housing 108.

The space 240 is used to house the controller 228, which includes electrical components to receive electrical power from an outlet and supply appropriate current to the linear heating element 104 to generate heat. As described above, the controller 228 includes the control knob 126 to control the strip heating apparatus 100. The other space 242 is primarily used for a wire (not shown) that connects to the exposed end of the linear heating element 104, while the other end of the heating element is connected to the controller 228.

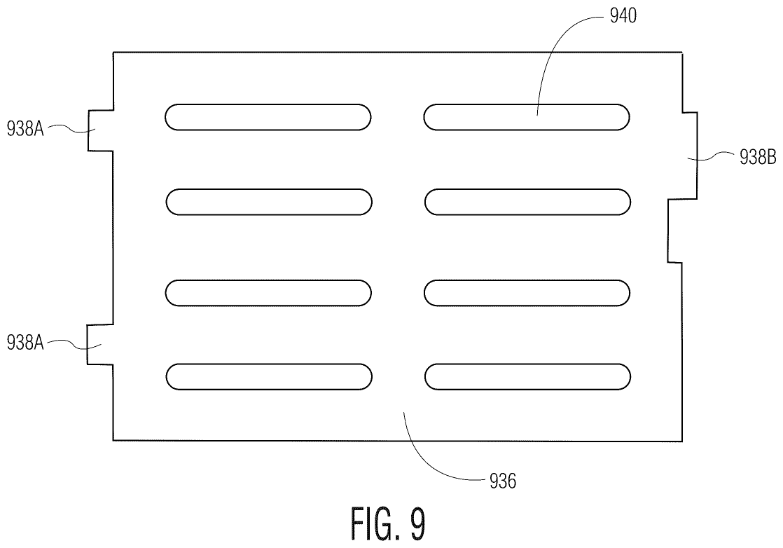

FIG. 9 shows a representative end bulkhead 936 in accordance with an embodiment of the invention. As shown in FIG. 9, the end bulkhead has the same form factor (i.e., shape or outline) as the support bulkhead 334. Thus, the end bulkhead 936 includes protrusions in the form of tabs 938A and 938B similar to the tabs 336A and 336B of the support bulkhead 334, which are used to secure the end bulkhead to the outer housing 108. The end bulkhead 936 is a vented bulkhead. Thus, the end bulkhead 936 includes vents 940, which may be in the shape of rounded rectangles, as illustrated in FIG. 9 or in any other shape.

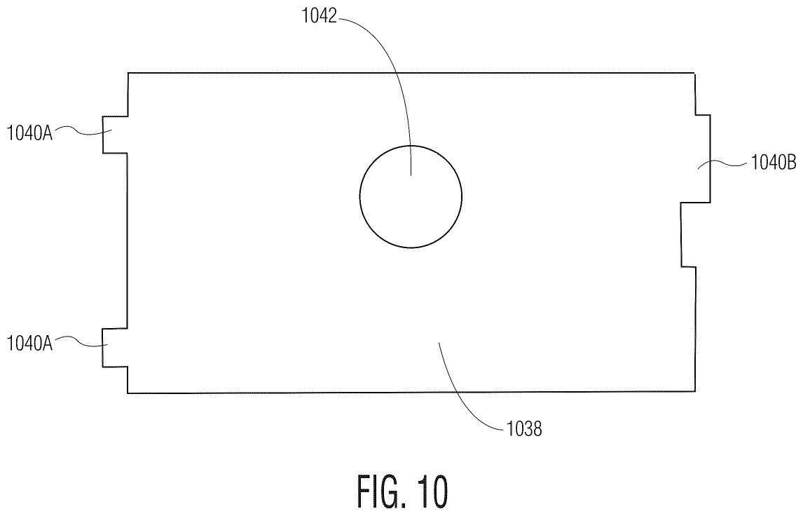

FIG. 10 shows a representative heating element bulkhead 1038 in accordance with an embodiment of the invention. Similar to the end bulkhead 936, the heating element bulkhead 1038 has the same form factor (i.e., shape or outline) as the support bulkhead 334. Thus, the heating element bulkhead 1038 also includes protrusions in the form of tabs 1040A and 1040B similar to the tabs 336A and 336B of the bulkhead 334, which are used to secure the heating element bulkhead to the outer housing 108. The heating element bulkhead 1038 includes a single opening 1042 for the linear heating element 104. The opening 1042 is in the shape of a circle in the illustrated embodiment. However, in other embodiments, the opening 1042 can be in any shape as long as it is large enough to insert the linear heating element 104.

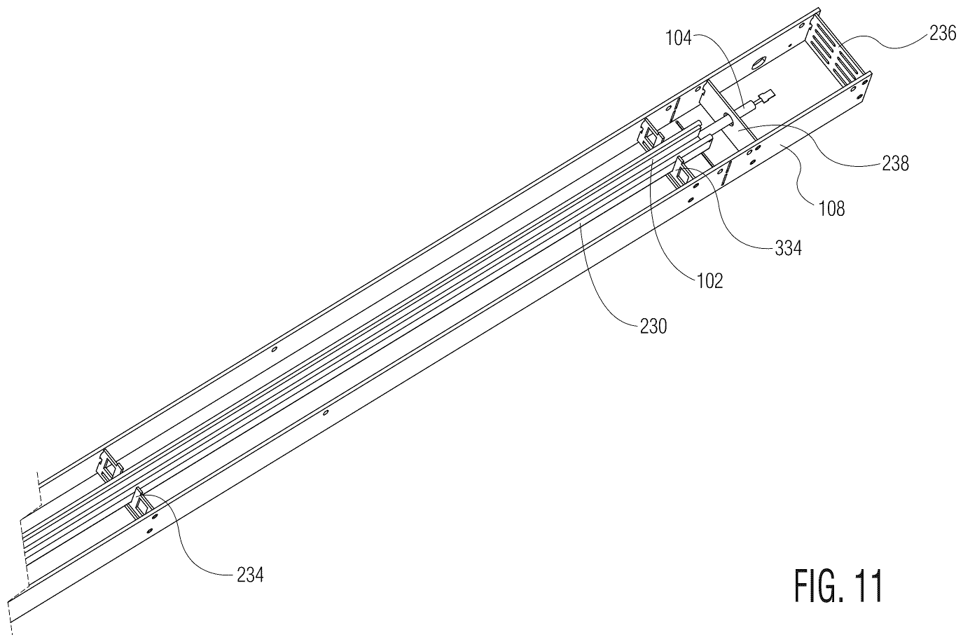

FIG. 11 is a perspective view of one of the end bulkheads 236 and one of the heating element bulkheads 238 positioned within the outer housing 108 in accordance with an embodiment of the invention. As shown in FIG. 11, the end bulkhead 236 is positioned at one of the ends of the outer housing 108 and the heating element bulkhead 238 is positioned next to the end bulkhead. Similar to the support bulkheads 234, the end bulkhead 236 and the heating element bulkhead 238 are secured to the outer housing 108 using the protrusions in the form of tabs of the bulkheads. The heating element bulkhead 238 is positioned in the outer housing 108 so that the linear heating element 104, which is supported by the support bulkheads 234, extends through the opening in the heating element bulkhead 238.

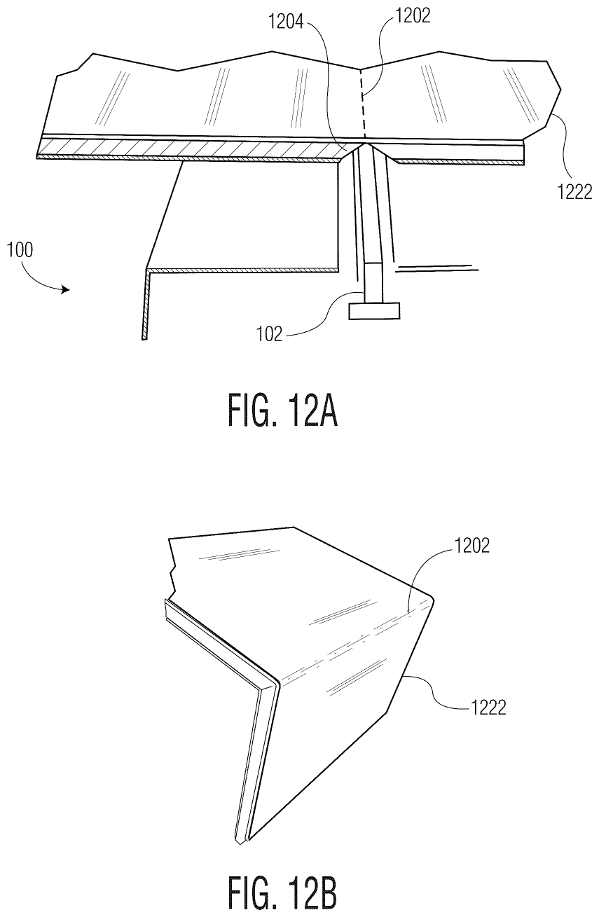

With reference to FIGS. 12A and 12B, a process of using the strip heating apparatus 100 in accordance with an embodiment of the invention is described. After plugging in the power cord 130 of the strip heating apparatus 100 into an electrical outlet, the strip heating apparatus is preheated by rotating the control knob 126 to a preheating setting for an appropriate amount of time, e.g., ten (10) to fifteen (15) minutes. The control knob 126 of the strip heating apparatus 100 is then rotated to a numerical setting that corresponds to a desired operating temperature. The strip heating apparatus 100 is now ready to be used.

A target plastic-containing object 1222 is then placed on the exposed linear T bar 102 of the strip heating apparatus 100, as illustrated in FIG. 12A. Specifically, the exposed linear T bar 102 is placed along a straight line 1202 on the target plastic-containing object 1222, where the target plastic-containing object will be bent or folded. In an embodiment, a V groove 1204 may be first made in the target plastic-containing object 1222 to remove the non-malleable layer of the target object, such as wood. This V groove 1204 may be made in the target plastic-containing object 1222 using a V shaped router bit. After few seconds, the target plastic-containing object 1222 can be bent to a desired angle, as illustrated in FIG. 12B.

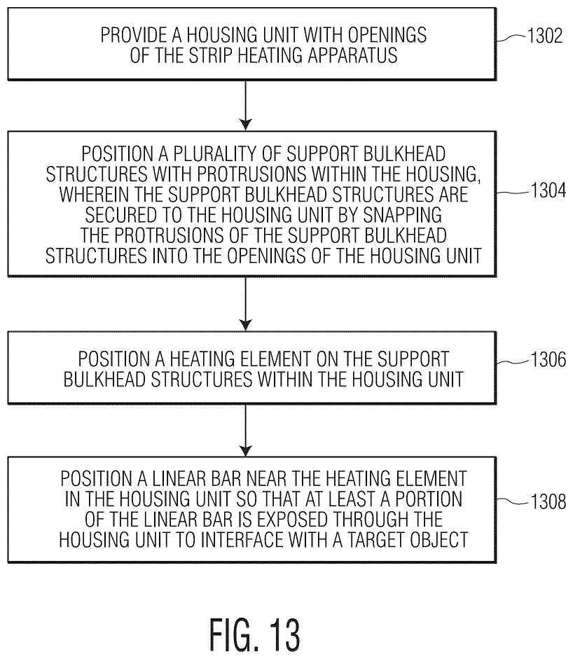

A method of producing a strip heating apparatus, such as the strip heating apparatus 100, in accordance with an embodiment of the invention is described with reference to a process flow diagram of FIG. 13. At block 1302, a housing unit with openings of the strip heating apparatus is provided. At block 1304, a plurality of support bulkhead structures with protrusions is positioned within the housing, wherein the support bulkhead structures are secured to the housing unit by snapping the protrusions of the support bulkhead structures into the openings of the housing unit. At block 1306, a heating element is positioned on the support bulkhead structures within the housing unit. At block 1308, a linear bar is positioned near the heating element in the housing unit so that at least a portion of the linear bar is exposed through the housing unit to interface with a target object.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A strip heating apparatus comprising:
a housing unit with openings;
a plurality of support bulkhead structures with protrusions positioned within the housing unit, the support bulkhead structures being secured to the housing unit by the protrusions of the support bulkhead structures in the openings of the housing unit;
a heating element positioned on the support bulkhead structures within the housing unit; and
a linear bar positioned near the heating element and secured in the housing unit so that at least a portion of the linear bar is exposed through the housing unit to interface with a target object.

2. The strip heating apparatus of claim 1, wherein the linear bar is a linear T bar and wherein the at least a portion of the linear bar is a portion of a stem of the linear T bar.

3. The strip heating apparatus of claim 1, wherein each of the support bulkhead structures includes a support portion with a concaved surface and wherein the heating element is positioned on the concaved surfaces of the support bulkhead structures.

4. The strip heating apparatus of claim 3, further comprising a channel structure positioned on the support bulkhead structures so that the support portions of the support bulkhead structure extend through expansion groove openings in the channel structure.

5. The strip heating apparatus of claim 4, wherein the support portions of the support bulkhead structure are secured to the channel structure using hitch pins through pin holes the support portions.

6. The strip heating apparatus of claim 4, further comprising at least one bar support positioned within the channel structure to support the linear bar.

7. The strip heating apparatus of claim 3, wherein each of the support bulkhead structures includes multiple voids.

8. The strip heating apparatus of claim 1, further comprising an end bulkhead structure and a heating element bulkhead structure positioned in the housing unit, wherein the end bulkhead structure and the heating element bulkhead create a space within the housing unit.

9. The strip heating apparatus of claim 8, further comprising a controller positioned in the space within the housing unit, the controller being connected to the heating element to provide electrical power to the heating element.

10. The strip heating apparatus of claim 8, wherein the end bulkhead structure and the heating element bulkhead structure have a same form factor as the support bulkhead structures.

11. A method of producing a strip heating apparatus, the method comprising:
providing a housing unit with openings of the strip heating apparatus;
positioning a plurality of support bulkhead structures with protrusions within the housing, wherein the support bulkhead structures are secured to the housing unit by snapping the protrusions of the support bulkhead structures into the openings of the housing unit;
positioning a heating element on the support bulkhead structures within the housing unit; and
positioning a linear bar near the heating element in the housing unit so that at least a portion of the linear bar is exposed through the housing unit to interface with a target object.

12. The method of claim 1, wherein the linear bar is a linear T bar and wherein the at least a portion of the linear bar is a portion of a stem of the linear T bar.

13. The method of claim 1, wherein each of the support bulkhead structures includes a support portion with a concaved surface and wherein the heating element is positioned on the concaved surfaces of the support bulkhead structures.

14. The method of claim 13, further comprising positioning a channel structure on the support bulkhead structures so that the support portions of the support bulkhead structure extend through expansion groove openings in the channel structure.

15. The method of claim 14, wherein the support portions of the support bulkhead structure are secured to the channel structure using hitch pins through pin holes the support portions.

16. The method of claim 14, further comprising positioning at least one bar support within the channel structure to support the linear bar.

17. The method of claim 13, wherein each of the support bulkhead structures includes multiple voids.

18. The method of claim 11, further comprising positioning an end bulkhead structure and a heating element bulkhead structure in the housing unit, wherein the end bulkhead structure and the heating element bulkhead create a space within the housing unit.

19. The method of claim 11, further comprising positioning a controller in the space within the housing unit, the controller being connected to the heating element to provide electrical power to the heating element.

20. A strip heating apparatus comprising:
a housing unit with openings;
a plurality of support bulkhead structures with tabs positioned within the housing unit, the support bulkhead structures being secured to the housing unit by the tabs of the support bulkhead structures in the openings of the housing unit;
a linear heating element positioned on the support bulkhead structures within the housing unit; and
a linear T bar positioned near the linear heating element in the housing unit so that at least a portion of a stem of the linear T bar is exposed through the housing unit to interface with a target object.
